(19) United States
(12) Patent Application Publication
(10) Pub. No.: US 2026/0134284 A1
(43) Pub. Date: May 14, 2026

(54) ADAPTIVE COMPUTATIONAL NODE SYSTEMS, METHODS, AND APPARATUSES

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/386,327

(22) Filed: Nov. 12, 2025

Related U.S. Application Data
(60) Provisional application No. 63/719,201, filed on Nov. 12, 2024.
(60) Provisional application No. 63/723,573, filed on Nov. 21, 2024.

(51) Int. Cl. G06N 3/082; G06F 18/21; G06F 21/53; G06N 3/063

(52) U.S. Cl. CPC G06N 3/082; G06F 18/217; G06F 21/53; G06N 3/063

(57) ABSTRACT

The present disclosure sets forth systems, apparatuses, and methods that autonomously adapt networks to acquire additional capabilities and/or optimize current capabilities. An example system comprises processors and memory that stores instructions to be executed to monitor first performance metrics of a first network, determine, based on the monitored first performance metrics, network patterns indicative of network inefficiencies or inabilities, determine, based on the determined network patterns, a network mutation, create, based on the first network and the network mutation, a second network, compare the first performance metrics of the first network to second performance metrics of the second network, and based on determining that the second performance metrics are an improvement over the first performance metrics by a threshold amount, apply the network mutation to the first network.

### CROSS REFERENCE TO RELATED APPLICATIONS

This patent claims priority to and the benefit of U.S. Provisional Patent Application No. 63/719,201, filed on Nov. 12, 2024, entitled “Self-Adaptive Computational Node Network,” and U.S. Provisional Patent Application No. 63/723,573, filed on Nov. 21, 2024, entitled “Self-Adaptive Computational Node Network.” U.S. Provisional Patent Application No. 63/719,201 and U.S. Provisional Patent Application No. 63/723,573 are hereby incorporated herein by reference in their entireties.

### FIELD OF THE DISCLOSURE

This disclosure relates generally to adaptive computational node systems, methods, and apparatuses.

### BACKGROUND

Network mechanics have changed in recent years to become more dynamic. Yet the process of updating network topologies-being manually hard coded by humans—has generally remained static.

### BRIEF DESCRIPTION OF THE DRAWINGS

FIG. 1 is a perspective view of an example network architecture in accordance with teachings of this disclosure.

FIG. 2 is a perspective view of an example network topology showing nodes and connections in accordance with teachings of this disclosure.

FIG. 3 is a block diagram of a self-adaptive layer for implementing network topology adaptations in accordance with teachings of this disclosure.

FIG. 4 is a block diagram of an adaptive computational node system comprising the self-adaptive layer of FIG. 3 interacting with additional core layers in accordance with teachings of this disclosure.

FIG. 5 is a block diagram of one of the additional core layers of FIG. 4 in accordance with teachings of this disclosure.

FIG. 6 is a block diagram of another one of the additional core layers of FIG. 4 in accordance with teachings of this disclosure.

FIG. 7 is a block diagram of another one of the additional core layers of FIG. 4 in accordance with teachings of this disclosure.

FIG. 8 is a flow diagram illustrating operation of the adaptive computational node system of FIG. 4 in accordance with teachings of this disclosure.

FIG. 9 is a block diagram of a neural network at a first time in accordance with teachings of this disclosure.

FIG. 10 is a block diagram of a mutated version of the neural network of FIG. 9 at a second time in accordance with teachings of this disclosure.

FIG. 11 is a block diagram of a mutated version of the neural network of FIG. 10 at a third time in accordance with teachings of this disclosure.

FIG. 12 is a timing diagram illustrating exemplary interactions between the core layers of FIG. 4 in accordance with teachings of this disclosure.

FIG. 13 is a timing diagram illustrating exemplary interactions between the components of the core layers of FIGS. 5-7 in accordance with teachings of this disclosure.

FIG. 14 is a timing diagram illustrating network mutations in accordance with teachings of this disclosure.

FIG. 15 is a timing diagram illustrating network topology transitions in accordance with teachings of this disclosure.

FIG. 16 is a flow chart illustrating an adaptation cycle of the self-adaptive layer of FIG. 3 in accordance with teachings of this disclosure.

FIG. 17 is a timing diagram illustrating a first portion of the adaptation cycle of FIG. 16 in accordance with teachings of this disclosure.

FIG. 18 is a timing diagram illustrating a second portion of the adaptation cycle of FIG. 16 in accordance with teachings of this disclosure.

FIG. 19 is a timing diagram illustrating a third portion of the adaptation cycle of FIG. 16 in accordance with teachings of this disclosure.

FIG. 20 is a timing diagram illustrating a fourth portion of the adaptation cycle of FIG. 16 in accordance with teachings of this disclosure.

FIG. 21 is a flow chart illustrating an example implementation of portions of the adaptation cycle of FIG. 16 in accordance with teachings of this disclosure.

FIG. 22 is a flow chart illustrating another example implementation of portions of the adaptation cycle of FIG. 16 in accordance with teachings of this disclosure.

FIG. 23 is a flow chart illustrating another example implementation of portions of the adaptation cycle of FIG. 16 in accordance with teachings of this disclosure.

FIG. 24 is a flow chart illustrating another example implementation of portions of the adaptation cycle of FIG. 16 in accordance with teachings of this disclosure.

FIG. 25 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

The present disclosure relates to systems, methods, and apparatuses for autonomously adapting computational node networks during runtime. In today's rapidly evolving technological landscape, networks have transformed from static systems into complex, dynamic environments. Factors such as changing contexts, evolving topologies, and non-deterministic outputs from network nodes necessitate innovative approaches that can handle these new challenges. However, to date, network topology changes are generally hard coded by people and rolled out to users. In contrast, the systems, methods, and apparatuses described herein present an architectural pattern where a network of computational nodes may autonomously modify its topology during runtime. The systems, methods, and apparatuses described herein may establish, create, adjust, and/or remove or ignore nodes and/or connections without human intervention and deploy these adaptations without downtime. Unlike traditional static networks, the systems, methods, and apparatuses described herein may autonomously adapt to changing requirements, optimize performance, and evolve network structure based on real-time analysis and feedback.

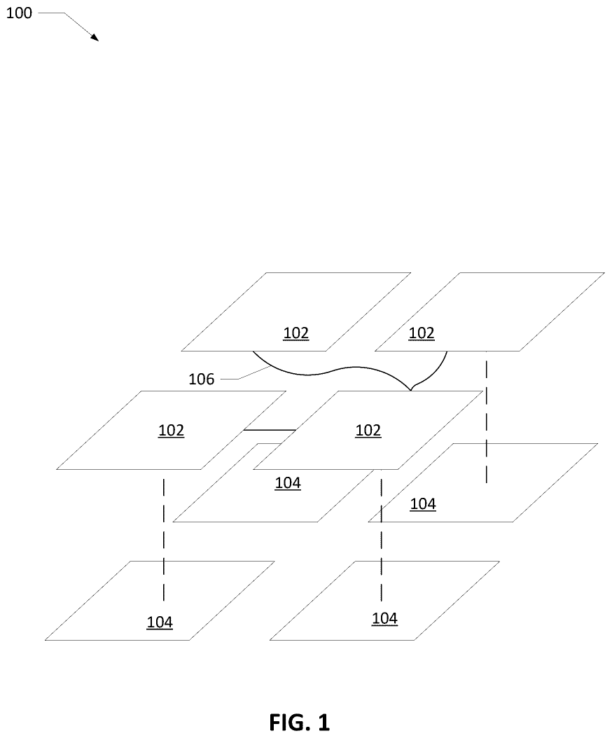

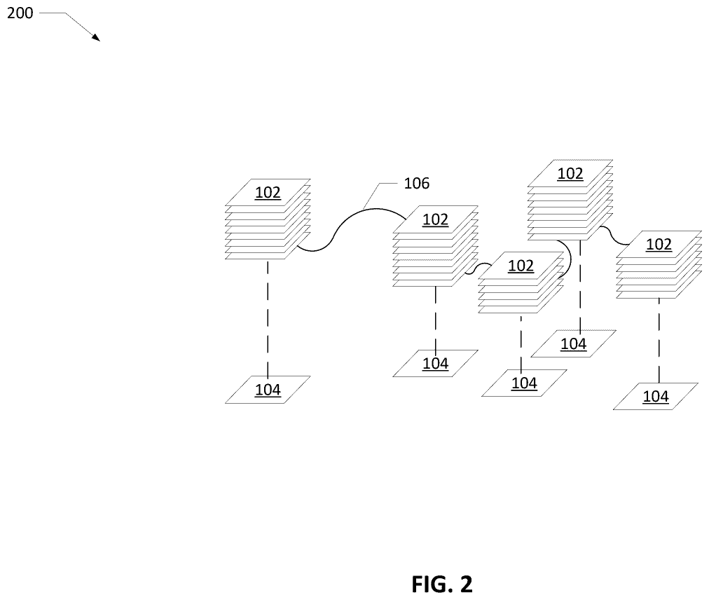

FIGS. 1-2 illustrate example network architectures in which the adaptive computational node systems, methods, and apparatuses described herein may be implemented. The example networks may comprise a plurality of nodes 102, 104 interconnected by connections 106, where the nodes and connections may be dynamically created, adapted, or destroyed during operation. In some examples, nodes may be generated, adapted, modified, or eliminated dynamically in real time to constantly adapt to ever-changing inputs. Furthermore, nodes may establish, create, adjust, ignore, or block their own connections to other nodes such that the neural network adapts not only by the number of nodes, but also by their interconnections. The ever-changing number of nodes and the connections therebetween may produce different outputs for a same given input, enabling non-deterministic behavior. The specific architecture shown in FIGS. 1-2 represents one possible embodiment, but the disclosed systems and methods are applicable to various network configurations and topologies.

In some examples, such network adaptations or mutations may result from the networks described herein attempting to accomplish a task (e.g., respond to a query through physical, written, or vocal actions). In some examples, tasks may be a series of nested objectives with individual neurons or nodes of a network handling respective objectives in the series of nested objectives. For example, a simple task of “make a shopping list for me” may involve sub-objectives such as: obtain a canvas (e.g., digital or paper) for the list, obtain a tool for modifying the canvas (e.g., an input device like a keyboard or stylus for digital canvas or a pencil, pen, marker, crayon, paintbrush, or the like for paper canvas), listen for items to add to the list, physically modify canvas to include the heard items, wait for additional items, open a refrigerator, freezer, and/or kitchen cabinets, check current inventory, compare current inventory to prior inventory, determine missing inventory based on comparison of current inventory to prior inventory, consider a number of people the shopping list is to supply, consider a number of additional people that may be joining a scheduled dinner, etc. These sub-objectives may have their own sub-objectives such as: look around for a canvas, look around for tool, enable microphone, power robotic arm, perform logical analyses, etc. Even the sub-objectives of the sub-objectives may have their own sub-objectives. The first sub-objectives of the sub-objectives as an example may involve opening drawers or cabinets where canvases are located, moving around in a first space/room, moving to a second space/room, obtaining a ladder or chair to reach locations currently out of reach, etc. Each node in a network may be able to process these sub-objectives of sub-objectives of sub-objectives such that the network as a whole may process the simple tasks of making a shopping list. In some examples, however, a static network may be unable to perform one of the sub-objectives of sub-objectives of sub-objectives, which would prevent successful completion of the task. In such an example, the systems, methods, and apparatuses described herein may identify such a limitation (or many other limitations such as inefficiencies in completing something already within the capabilities of the network) and adapt the network (e.g., by establishing, adding, removing, ignoring, or otherwise adjusting or mutating the nodes and/or connections) to accomplish the task.

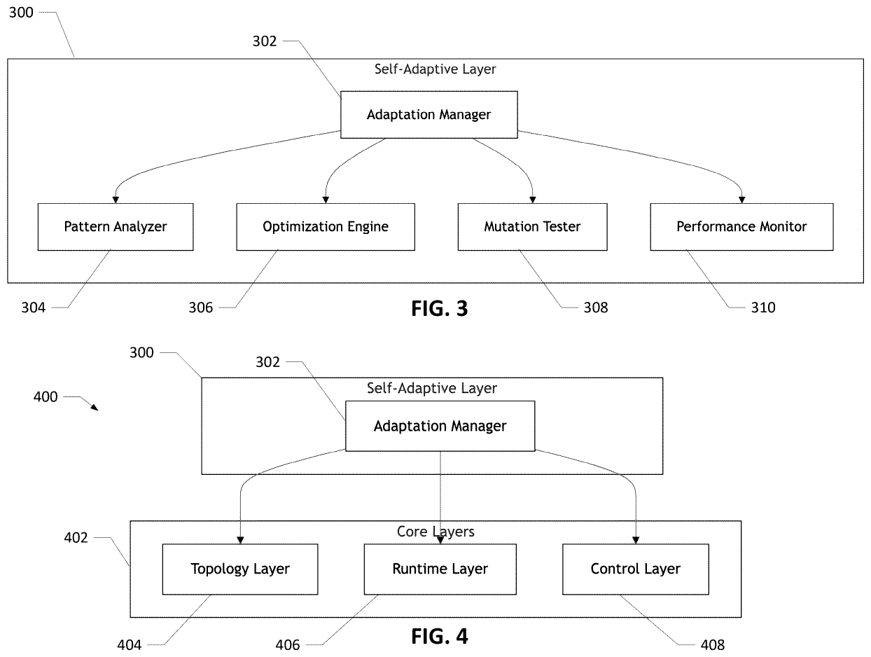

FIG. 3 illustrates an example self-adaptive layer 300 to implement the establishment creation, adjustment, and/or removal nodes and/or connections. The example self-adaptive layer 300 orchestrates the autonomous behavior of the network. For example, the self-adaptive layer 300 may implement the intelligence that drives the self-adaptive capabilities. The self-adaptive layer 300 may comprise an adaptation manager 302, a pattern analyzer 304, an optimization engine 306, a mutation tester 308, and a performance monitor 310. The example adaptation manager 302 may coordinate overall self-adaptive operations and strategy. In some examples, the adaptation manager 302 may make high-level decisions about network evolution. The example adaptation manager 302 may manage inter-component communication and orchestration. And, the adaptation manager 302 may handle error recovery and fallback procedures.

The example pattern analyzer 304 may analyze signal flow patterns and identify bottlenecks. In some examples, the pattern analyzer 304 may suggest structural optimizations based on usage patterns. Furthermore, the example pattern analyzer 304 may map data dependencies and common pathways between nodes.

The example optimization engine 306 may generate and evaluate optimization proposals. In some examples, the optimization engine 306 may calculate cost-benefit ratios and prioritize improvements. The optimization engine 306 may predict performance impact of potential changes. Also, the optimization engine 306 may maintain optimization history and success metrics.

The example mutation tester 308 may create and validate topology mutations through A/B testing. In some examples, the mutation tester 308 may create and analyze a plurality of mutations within a sandbox isolated from the network. In some examples, the mutation tester 308 may create a plurality of network mutations based on the network topology and variations of context. In some examples, the mutation tester 308 may communicate with or prompt an inference engine (local or external) to generate candidate mutations of the network. In some such examples, the inference engine may be a large language model that proposes structural variations based on the network topology and optimization goals. In some examples, multiple inference engines may compete to generate diverse mutation proposals. In some examples, the mutation tester 308 may apply deterministic logic to generate mutations based on predefined rules. In some examples, the mutation tester 308 may combine inference engine proposals with deterministic logic constraints to generate mutations. In some examples, the mutation tester 308 may select one or more mutations of the plurality of mutations to analyze. For example, the mutation tester 308 may compare mutations to one or more thresholds and select one or more mutations that satisfy the one or more thresholds (e.g., to weed out mutations with low probability of success). In some examples, the mutation tester 308 may compare performance metrics of one (or more) network mutation(s) to performance metrics of one (or more) other network mutation(s) to select or ignore such network mutation(s) for application to the network. In some examples, the plurality of mutations may be stored for subsequent analysis by the mutation tester 308. In some examples, the stored mutations may decay over time such that created mutations that are infrequently selected may lose relevance over time, mimicking human memory where hypothetical scenarios that are repeatedly not selected gradually fade but remain accessible for reconsideration if circumstances change. In some examples, the mutation tester 308 ensures safe rollout with monitoring and rollback capabilities. Additionally, the mutation tester 308 may validate mutation compatibility and stability.

The example mutation tester 308 may implement a multi-stage evaluation process for candidate mutations. In a first stage, a large plurality of candidate mutations may be generated. For example, the mutation tester 308 may generate from 10 to 1000 candidate mutations, such as 50, 100, 200, or 500 variants. In a second stage, these candidate mutations may be executed in sandbox environments isolated from real-world systems and live network operations, where they can be observed and analyzed without affecting operational networks. The sandbox environments may enable the mutation tester 308 to evaluate hypothetical performance without committing resources to full deployment. Candidate mutations that produce execution errors, logical contradictions, or nonsensical outputs may be eliminated from consideration. In a third stage, remaining candidate mutations (e.g., the top 10%, 20%, or 30% of candidates based on hypothetical performance metrics) may be subjected to further refinement, combined with other surviving candidates, or advanced to real-world A/B testing. This winnowing process may mimic human deliberation where many ideas are considered mentally before committing to action, thereby enabling efficient exploration of the mutation space while avoiding costly deployment of unsuitable mutations.

Network mutations may occur at different hierarchical scales. At the finest granularity, a mutation may modify a single parameter within a node's configuration (e.g., a threshold value, a weight, or other configurable aspect of the node's operational characteristics). At intermediate scales, mutations may add, remove, or modify entire nodes or connections between nodes. At the coarsest scale, mutations may affect entire neural flows-collections of multiple interconnected nodes that function as a subsystem. The adaptation manager 302 may determine the appropriate scale for a given optimization goal. In some examples, mutations at different scales may be generated and evaluated simultaneously, with the mutation tester 308 comparing performance improvements across scales to select the most effective mutation regardless of its granularity.

The example performance monitor 310 may track network metrics and identifies performance issues. In some examples, the performance monitor 310 may trigger adaptation cycles based on configured thresholds. The example performance monitor 310 may collect and analyze resource utilization data. And, the example performance monitor 310 may maintain historical performance data and generate reports. In some examples, the performance monitor 310 may analyze new networks formed based on application of network mutations. In some examples, the performance monitor 310 may track whether or not applied mutations are successful (e.g., making the network more efficient, adding new capabilities, etc.), which may be used to provide positive or negative reinforcement of the same or similar network mutations in subsequent analyses.

In operation, the performance monitor 310 may analyze an initial network topology. In some examples, the performance monitor 310 receives an input image of the initial network topology. The example pattern analyzer 304 may analyze a workflow associated with the initial network topology. For example, the pattern analyzer 304 may identify performance bottlenecks. In some examples, the pattern analyzer 304 utilizes the analysis of the initial network topology from the performance monitor 310. The pattern analyzer 304 may create a proposed new network structure based on the workflow analysis. In some examples, the proposed new network comprises optimizations of the initial network topology. The example mutation tester 308 may analyze the proposed new network structure from the pattern analyzer 304. In some examples, the mutation tester 308 creates A/B testing configuration based on the analysis of the initial network topology and the analysis of the proposed new network structure. The example optimization engine 306 may determine if the proposed new network structure is an improvement over the initial network topology. If the optimization engine 306 determines that the proposed new network structure is an improvement over the initial network topology the adaptation manager 302 may deploy the proposed new network structure as an optimized topology.

FIG. 4 illustrates an example adaptive computational node system 400 in which the example self-adaptive layer 300 may interact with one or more core layers 402. The one or more core layers 402 may comprise a topology layer 404, a runtime layer 406, and a control layer 408. The example topology layer 404 may maintain a declarative network structure and may provide application programming interfaces (APIs) for modifying and querying the network topology. The example runtime layer 406 may manage the runtime execution of nodes in the network. The example control layer 408 may manage the control flow and coordination between the runtime and topology layers, keeping track of an internal state of each signal and position in the network.

The example adaptation manager 302 may be able to interact directly with the topology layer 404, the runtime layer 406, and/or the control layer 408. In some examples, the adaptation manager 302 may be a separate service that interacts with the one or more core layers 402. In some such examples, the adaptation manager 302 may interact with the one or more core layers 402 remotely over another network, wireless network, or the Internet.

The adaptation manager 302 may interact with the topology layer 404 in a number of ways. In some examples, the adaptation manager 302 (via interaction with the topology layer 404) may request and validate topology mutations. In some examples, the adaptation manager 302 (via interaction with the topology layer 404) may manage topology versions and change history. In some examples, the adaptation manager 302 (via interaction with the topology layer 404) may coordinate topology rollout strategies.

The adaptation manager 302 may interact with the runtime layer 406 in a number of ways. In some examples, the adaptation manager 302 (via interaction with the runtime layer 406) may monitor execution metrics and performance. In some examples, the adaptation manager 302 (via interaction with the runtime layer 406) may manage resource allocation and scaling. In some examples, the adaptation manager 302 (via interaction with the runtime layer 406) may optimize node execution patterns. In some examples, the adaptation manager 302 (via interaction with the runtime layer 406) may control runtime configuration parameters.

The adaptation manager 302 may interact with the control layer 408 in a number of ways. In some examples, the adaptation manager 302 (via interaction with the control layer 408) may analyze signal flow patterns and bottlenecks. In some examples, the adaptation manager 302 (via interaction with the control layer 408) may coordinate timing of adaptation changes. In some examples, the adaptation manager 302 (via interaction with the control layer 408) may manage signal routing during transitions. In some examples, the adaptation manager 302 (via interaction with the control layer 408) may maintain signal state consistency.

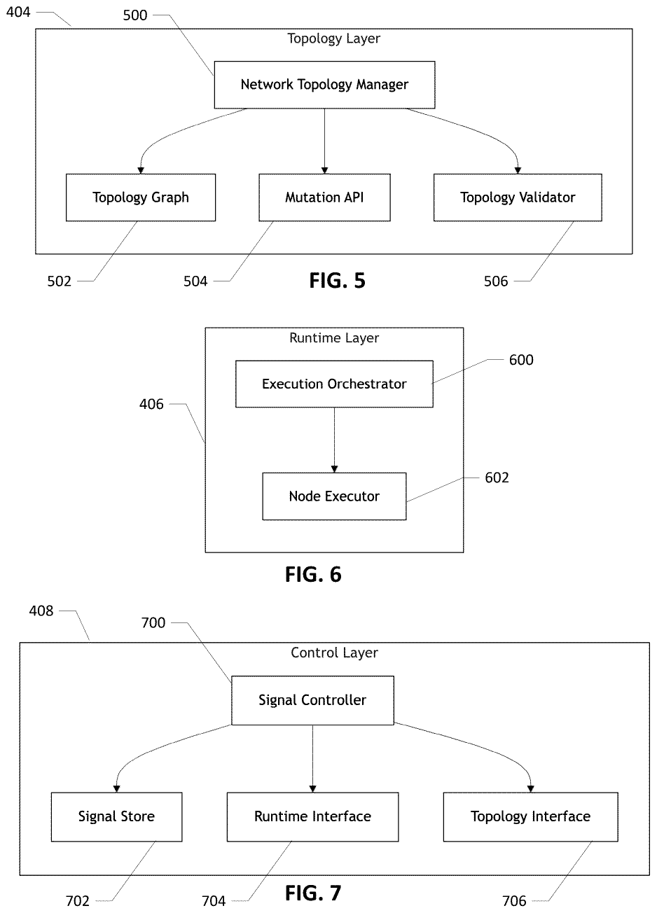

The example topology layer 404 is illustrated in more detail in FIG. 5. The example topology layer 404 may manage a network's structure. In some examples, the topology layer 404 provides interfaces for topology modifications. The example topology layer 404 may comprise a network topology manager 500, an example topology graph 502, an example mutation API 504, and example topology validator 506. The example network topology manager 500 orchestrates all topology-related operations. The example topology graph 502 maintains and stores the current network structure. In some examples, the topology graph 502 comprises one or more databases. The example mutation API 504 provides interfaces for facilitating topology modifications. In some examples, the topology modifications may comprise establishing or adding new nodes to the network, updating an existing node, removing a node from the network, ignoring a node within the network, adding a new connection between two existing nodes, updating metadata associated with an existing connection, and/or removing or ignoring a connection between two existing nodes. The example topology validator 506 ensures the validity of any proposed changes.

The example runtime layer 406 is illustrated in more detail in FIG. 6. The example runtime layer 406 may handle the execution of computational nodes. In some examples, the runtime layer 406 may perform signal processing as well. The example runtime layer 406 may comprise an example execution orchestrator 600 and an example node executor 602. The example execution orchestrator 600 coordinates the computational node execution, whereas the example node executor 602 performs individual node processing.

The example control layer 408 is illustrated in more detail in FIG. 7. The example control layer 408 may coordinate between the example topology layer 404 and runtime layer 406. In some examples, the control layer 408 may manage signal flow throughout the network. Example control layer 408 may comprise a signal controller 700, a signal store 702, a runtime interface 704, and a topology interface 706. The example signal controller 700 manages overall signal lifecycles. The example signal store 702 stores state of all signals. In some examples, the signal store 702 comprises one or more databases. The example runtime interface 704 enables communication with the example runtime layer 406. The example topology interface 706 enables communication with the example topology layer 404. In some examples, the topology layer 404 and/or the runtime layer 406 may have corresponding control layer interfaces to enable communications with the example control layer 408.

In some examples, the topology layer 404, the runtime layer 406, and the control layer 408 are separate in order to delineate individual concerns, independently scale components, simplify maintenance and updates, robustly handle errors, and efficiently utilize resources. In some examples, the topology layer 404, the runtime layer 406, and the control layer 408 may be combined together.

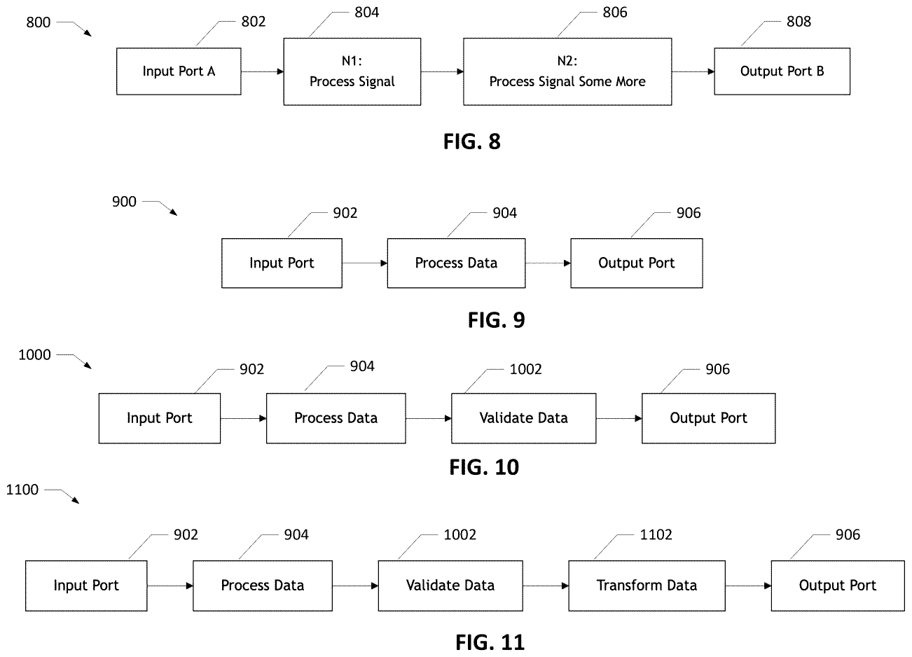

FIG. 8 illustrates an example process 800 for basic operation of the adaptive computational node system 400 of FIG. 4 in a neural network. Upon creation of a signal at an input port (input port A), the example control layer 408 may create a new signal instance (step 802). The control layer 408 may request that the execution orchestrator 600 of the runtime layer 406 execute the first node. At step 804, the execution orchestrator 600 of the runtime layer 406 may process the signal at the first node to produce a first output. Based on the first output, the execution orchestrator 600 of the runtime layer 406 may request the network topology manager 500 of the topology layer 404 provide a second (next) node for execution. The network topology manager 500 of the topology layer 404 may, based on the request, return the second node in the network. At step 806, the execution orchestrator 600 of the runtime layer 406 may process the signal at the second node to produce a second output. The signal may continue to traverse the neural network as described above until it reaches an output port (output port B) at step 808.

As described herein, however, the neural network may require change to, for example, add new features or capabilities, prune unused or obsolete features or capabilities, and/or optimize existing features or capabilities. For example, in order to process a particular query, a network may need to add a new node with new capabilities in order to accomplish processing of that query. In some examples, before a new node may be added to the network, the new node may have to be compatible with the network. For example, a new node may have to have schematic compatibility with both inputs and outputs of other nodes in the network. Schematic compatibility may require that data structures, formats, and protocols used by the new node match those expected by existing nodes to which it will connect. In some examples, the mutation tester 308 or topology validator 506 may verify this compatibility before allowing a mutation to proceed to real-world testing. In some such examples, when a new node is added, the input for the new node may be schematically compatible with the output of existing preceding nodes, and the output of the new node may be schematically compatible with the input of existing subsequent nodes. FIGS. 9-11 illustrate example adjustments or modifications of a neural network to add data validation and transformation capabilities. For example, in a given network 900, illustrated in FIG. 9, where a signal is created at an input port 902, processed at a processing node 904, and output at an output port 906, the self-adaptive layer 300 may determine a need for nodes configured to validate or transform the signal.

In some examples, the network topology manager 500 may initiate a modification to the network 900 to add a data validation node. In some examples, adding a node may additionally require removing or ignoring previous connections between nodes, updating existing connections, and/or adding new connections. For example, in the network 900 of FIG. 9, the processing node 904 may have a direct connection to the output port 906. However, in order for the data processed at the processing node 904 to be validated before being output, a new node may need to be added between the processing node 904 and the output port 906. In some such examples, the connection between the processing node 904 and the output port 906 may be removed or ignored, a new node may be added between the processing node 904 and the output port 906, and new connections between the processing node 904, the new node, and the output port 906 may be created or otherwise established. Alternatively, the connection between the processing node 904 and the output port 906 may be updated to connect to the new node instead of the output port 906. Similarly, the connection between the processing node 904 and the output port 906 may be updated to connect to the new node instead of the processing node 904.

As shown in FIG. 10, a new network 1000 implementing the above modifications is illustrated. The new network 1000 may comprise the input port 902 and the processing node 904 like in the network 900 of FIG. 9. However, the mutation API 504 may create a new data validation node 1002. The mutation API 504 may remove or ignore the previous connection between the processing node 904 and the output port 906 and establish or create a new connection between the processing node 904 and the new data validation node 1002. Alternatively, the mutation API 504 may update the prior connection between the processing node 904 and the output port 906 to be between the processing node 904 and the new data validation node 1002 instead. This may comprise modifying metadata associated with one end (e.g., the terminating end) of the connection. The mutation API 504 may further create or establish a new connection between the new data validation node 1002 and the output port 906. Alternatively, the mutation API 504 may update the prior connection between the processing node 904 and the output port 906 to be between the new data validation node 1002 and the output port 906 instead. This may comprise modifying metadata associated with one end (e.g., the starting end) of the connection. The new network 1000 may be stored in the topology graph 502.

In some examples, the network topology manager 500 may initiate a modification to the network 1000 to add a data transformation node. In order for the validated data to be transformed before being output, a new node may need to be added between the data validation node 1002 and the output port 906. In some such examples, the connection between the data validation node 1002 and the output port 906 may be removed, ignored, or otherwise disregarded, a new node may be established or added between the data validation node 1002 and the output port 906, and new connections between the data validation node 1002, the new node, and the output port 906 may be created or established. Alternatively, the connection between the data validation node 1002 and the output port 906 may be updated to connect to the new node instead of the output port 906. Similarly, the connection between the data validation node 1002 and the output port 906 may be updated to connect to the new node instead of the data validation node 1002.

As shown in FIG. 11, a new network 1100 implementing the above modifications is illustrated. The new network 1100 may comprise the input port 902 and the processing node 904 like in the network 900 of FIG. 9. However, the mutation API 504 may create or establish a new data validation node 1002 and a new data transformation node 1102. The mutation API 504 may remove, ignore, or disregard the previous connection between the processing node 904 and the output port 906 and create or establish a new connection between the processing node 904 and the new data validation node 1002. Alternatively, the mutation API 504 may update the prior connection between the processing node 904 and the output port 906 to be between the processing node 904 and the new data validation node 1002 instead. This may comprise modifying metadata associated with one end (e.g., the terminating end) of the connection. The mutation API 504 may further create a new connection between the new data validation node 1002 and the output port 906. Alternatively, the mutation API 504 may update the prior connection between the processing node 904 and the output port 906 to be between the new data validation node 1002 and the output port 906 instead. This may comprise modifying metadata associated with one end (e.g., the starting end) of the connection.

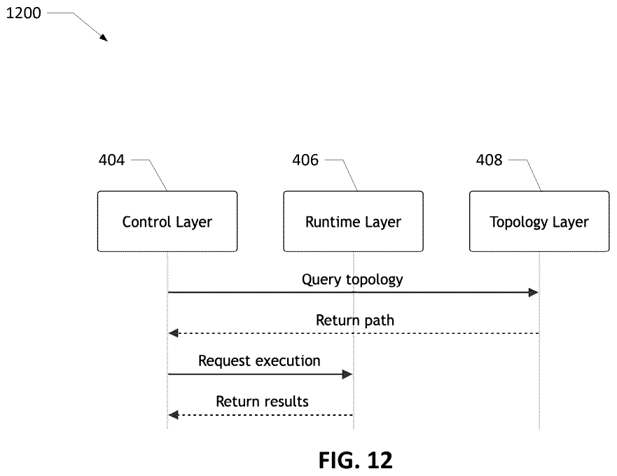

FIG. 12 is a timing diagram illustrating network level operation of signals traversing a network. FIG. 12 may be illustrative of a process 1200, which may begin when the control layer 408 sends a query to the topology layer 404 for the current network topology. In response, the topology layer 404 may return the current network structure to the control layer 408. In some examples, the control layer 408 may then request that the runtime layer 406 perform execution according to the current network topology. The example runtime layer 406 may respond with the results of such execution to the control layer 408.

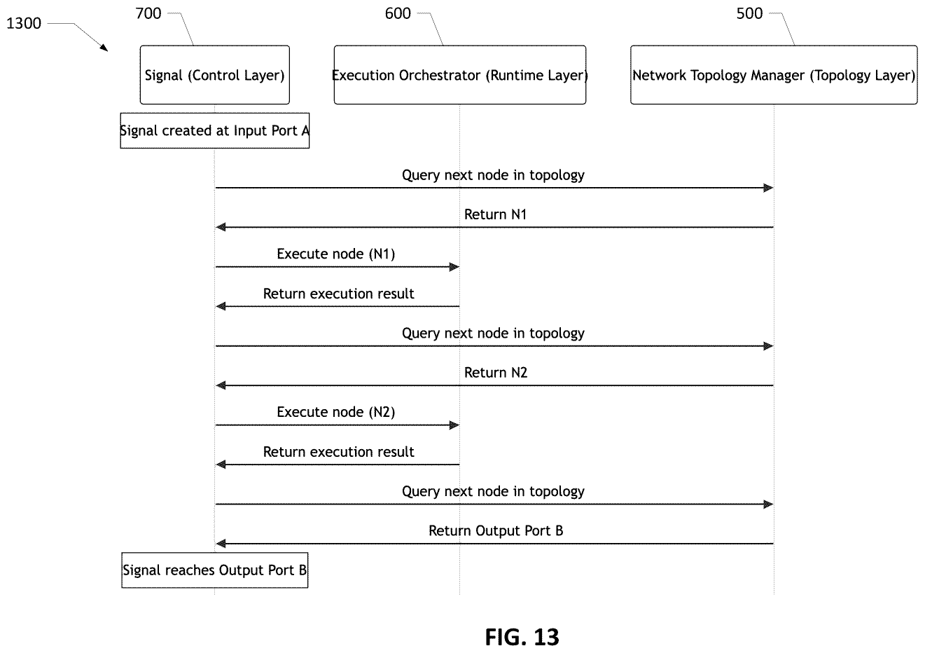

FIG. 13 is a timing diagram illustrating node level normal operation of signals traversing a network. FIG. 13 may be illustrative of a process 1300, which may begin when the signal controller 700 of the control layer 408 receives a signal created at an input port (e.g., input port A). Like the process 1200 illustrated in FIG. 12, the signal controller 700 of the control layer 408 may send a query to the topology layer 404, and more specifically the network topology manager 500, for the current network topology. In response, the network topology manager 500 of the topology layer 404 may return a first node to the signal controller 700. The signal controller 700 may then request that the execution orchestrator 600 of the runtime layer 406 execute the first node (e.g., cause processing of a signal according to the capabilities of the first node such as, calculations, image processing, language processing, etc.). The execution orchestrator 600 may then return the execution results to the signal controller 700. The signal controller 700 can then query the next node in the network topology from the network topology manager 500. In some examples, the network topology manager 500 returns a second node to the signal controller 700.

The signal controller 700 may then request that the execution orchestrator 600 of the runtime layer 406 execute the second node. The execution orchestrator 600 may then return the execution results to the signal controller 700. The signal controller 700 can then query the next node in the network topology from the network topology manager 500. This sequence may continue for as many nodes in a particular route through the network. In some examples, the network topology manager 500 may, in response to a query for the next node, determine that an output port is the next component in the network. In some such examples, the network topology manager 500 may return the output port (e.g., output port B) to the signal controller 700. The signal controller 700 may direct the signal to the output port based on returned output port from the network topology manager 500. In some examples, the signal store 702 may store both the signal that was created at the input port as well as the signal directed to the output port to maintain the states of signals passing through the network.

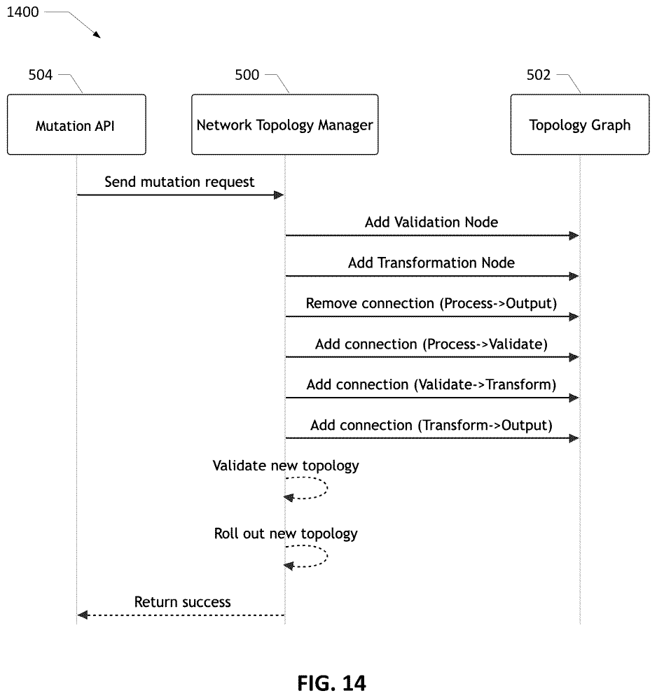

In some examples, before, after, or during normal operation, the network topology may need to be adjusted or adapted. For example, there may be a portion of a query that the current network topology does not have the capabilities of addressing. As another example, the network topology could be optimized to improve processing. In some such examples, the network topology manager 500 may determine to adjust, modify, or otherwise mutate the network. FIG. 14 illustrates an example timing diagram of an implementation of such a mutation. An example network mutation process 1400 may begin with the mutation API 504 (of the topology layer 404 of FIG. 5) sending a mutation request to the network topology manager 500. Using the example described with reference to FIGS. 9-11, the network topology manager 500 may initiate a modification to the network to add a data validation node and a transformation node. In some examples, the network topology manager 500 instructs the topology graph 502 to add a data validation node (e.g., the data validation node 1002 of FIG. 10) and a data transformation node (e.g., the data transformation node 1102 of FIG. 11) to the network representation. As described above with respect to FIGS. 9-11, in addition to adding the data validation and data transformation nodes to the network, the existing node connections may need to be removed, ignored, or updated, and new connections may need to be established or added. In some such examples, the network topology manager 500 may instruct the topology graph 502 to remove, ignore, or disregard one or more existing node connections and establish or add one or more new node connections. For example, the network topology manager 500 may instruct the topology graph 502 to remove, ignore, or disregard the node connection between the processing node 904 and the output port 906, establish or add a first new node connection between the processing node 904 and the data validation node 1002, establish or add a second new node connection between the data validation node 1002 and the data transformation node 1102, and establish or add a third new connection between the data transformation node 1102 and the output port 906. In some such examples, the topology validator 506 may validate the new network topology with the added nodes/connections (and removed/ignored connection). In some examples, the network topology manager 500 may roll out the new topology based on the validation of the new network topology being successful. After a successful roll out of the new topology, the network topology manager 500 may indicate to the mutation API that the mutation request was implemented successfully. In some examples, the performance monitor 310 may track whether or not applied mutations are successful (e.g., making the network more efficient, adding new capabilities, etc.), which may be used to provide positive or negative reinforcement of the same or similar network mutations in subsequent analyses.

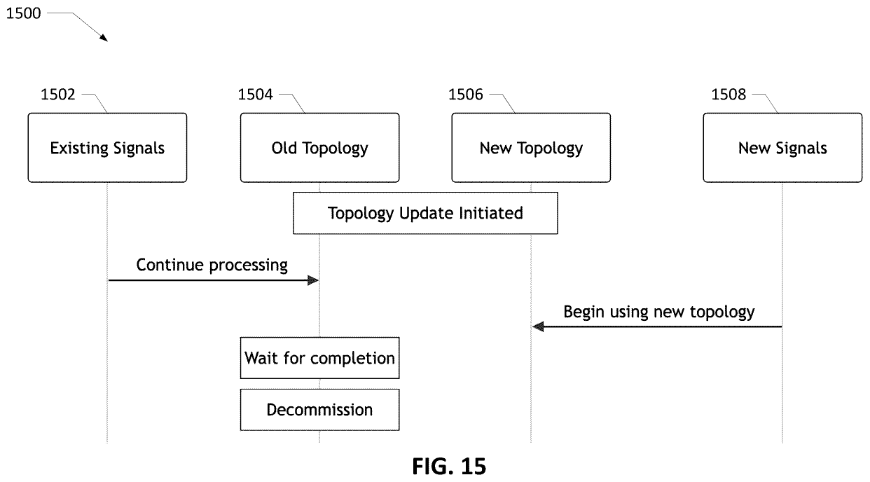

As described above, the network topology manager 500 may initiate a network mutation during normal operation of the network. FIG. 15 is a timing diagram illustrating an example process 1500 for implementing a topology update during normal operation where the network is processing existing signals 1502. In some examples, the process 1500 may initiate a graceful transition ensuring that there is no signal or data loss during topology updates and that topology versions are predictably tracked. Once a topology update is initiated, the existing signals 1502 may continue to be processed under the old topology 1504. In some such examples, the existing signals 1502 may traverse the network and the old topology 1504 may continue to exist until processing of such existing signals is completed. Thereafter, the old topology 1504 may be decommissioned. In some examples, the new topology 1506 may be utilized by new signals 1508 as soon as possible. In some examples, the old topology 1504 and the new topology 1506 may co-exist if processing of the existing signals 1502 is incomplete when the new signals 1508 arrive. Because each signal may be independent, multiple signals can be created or exist at the same time, and may traverse the network in parallel.

In some examples, the new topology 1506 may be immediately transitioned from the old topology 1504. In some such examples, immediate transition may result in some signals, such as those traversing paths that no longer exist under the new topology, being lost. In some such examples, immediate transition may result in some signals traversing new paths (e.g., instead of being lost).

In some examples, each topology modification may result in a new version of the network. In some such examples, versioning may enable the example adaptive computational node system 400 (and more specifically the self-adaptive layer 300) to track the evolution of the network over time, roll back to previous versions if needed, maintain audit trails of structural changes, support A/B testing between versions, and ensure consistency during transitions. In some examples, the example adaptive computational node system 400 (and more specifically the topology graph 502) may store a version history that may include a complete topology snapshot, mutation details and rationale, and version rollout/rollback history.

The example adaptive computational node system 400 may support granular update strategies including subnetwork isolation, traffic control, and parallel operation. In some examples, a granular approach may minimize disruption while ensuring version clarity and maintaining network stability during updates. In some examples, subnetwork isolation may beneficially pause only affected subnetwork sections, flush signals in modified paths, and apply changes while rest of network continues operating. In some examples, traffic control may beneficially place “stop signals” before modified sections, hold new signals until an update completes, and resume traffics flow with new topology. In some examples, parallel operation may beneficially allow old and new topologies to run simultaneously (if I/O compatible), shift traffic to new topology gradually, and validate new topology before full cutover.

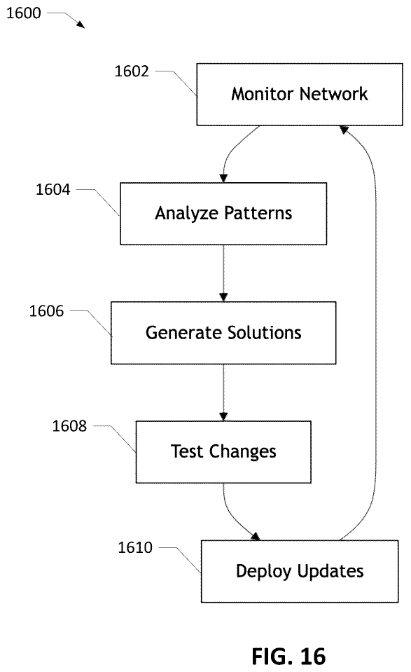

FIG. 16 is a flow chart illustrating an adaptation cycle 1600 of the self-adaptive layer 300. As illustrated in FIG. 16, the adaptation cycle 1600 may be cyclical, such that it may operate continuously. Because of this, there may be various starting points, but for the purposes of describing the adaptation cycle 1600, it may begin with the performance monitor 310 monitoring the network at step 1602. In some examples, the performance monitor 310 may collect metrics and performance data. In some examples, the performance monitor 310 may report results of its monitoring to the pattern analyzer 304. At step 1604, the pattern analyzer 304 may analyze patterns associated with the network. In some examples, the analysis associated with the network may be based on reported results of the monitoring by the performance monitor 310. In some examples, the example optimization engine 306 may generate optimization proposals based on the patterns analyzed by the pattern analyzer 304. In some examples, the pattern analyzer 304 and the optimization engine 306 may work together to identify patterns and improvement opportunities.

At step 1606, the example mutation tester 308 may, based on the patterns analyzed by the pattern analyzer 304 and/or optimization proposals generated by the optimization engine 306, generate (potential) solutions to improve the network. In some examples, the example mutation tester 308 may create topology mutations including establishing, adding, updating, removing, ignoring, or disregarding nodes and/or connections. At step 1608, the mutation tester 308 may evaluate the optimization solutions and/or the topology mutations. In some examples, the mutation tester 308 may validate the solutions/mutations based on its evaluation. In some examples, the mutation tester 308 may validate the solutions/mutations in isolated environments. In some examples, the adaptation manager 302 may, based on the optimized solutions and/or the topology mutations being validated by the mutation tester 308, deploy such solutions as network updates at step 1610. Thereafter, the adaptation cycle 1600 may return to step 1602. Of course, the adaptation cycle 1600 may begin at any of the above steps. In some examples, the adaptation cycle 1600 may continuously monitor the network at step 1602 (monitoring the network) until a certain circumstances trigger the adaptation cycle to proceed to step 1604.

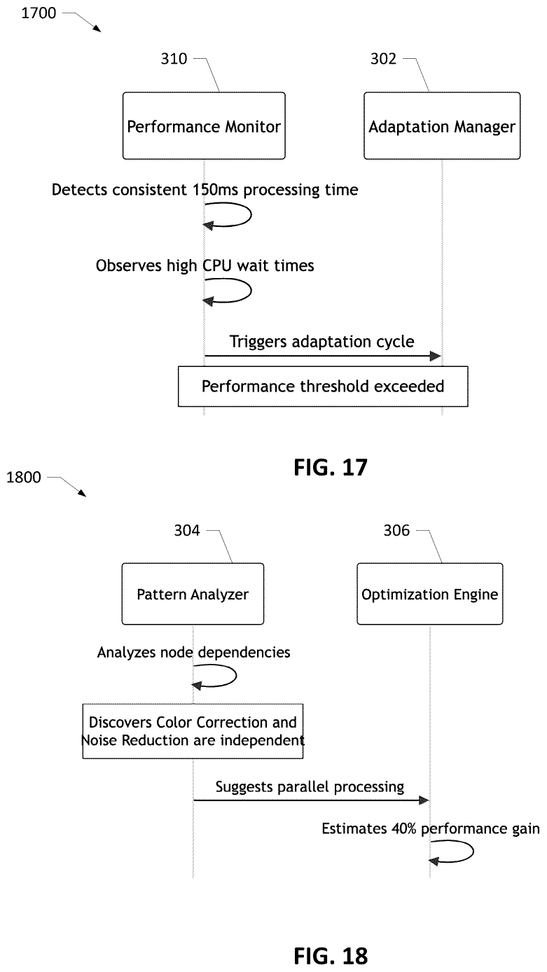

FIGS. 17-20 illustrate an example implementation of the adaptation cycle 1600 in an image correction context. For example, FIG. 17 is a timing diagram illustrating a process 1700 for triggering the adaptation cycle 1600. For example, the performance monitor 310 may determine inefficiencies during its monitoring of the network at step 1602 of the adaptation cycle 1600. In some examples, the performance monitor 310 may set any number of performance thresholds and compare current network performance to such thresholds. For example, the performance monitor 310 may detect consistent 150 ms processing times for performing color correction and noise reduction during image correction. As another example, the performance monitor 310 may detect high CPU wait times. Based on determining one or more inefficiencies in the network, the performance monitor 310 may trigger the adaptation cycle 1600 (FIG. 16). In some examples, the performance monitor 310 may trigger the adaptation cycle 1600 when current network performance exceeds one or more of the performance thresholds.

FIG. 18 is a timing diagram illustrating a process 1800 for implementing step 1604 (analyzing patterns) of the adaptation cycle 1600, in which the pattern analyzer 304 and the optimization engine 306 may work together. For example, the pattern analyzer 304 may analyze node dependencies in the network. In some examples, such as for image correction, the example pattern analyzer 304 may determine that both color correction and noise reduction are needed to correct an image. In some such examples, the pattern analyzer 304 may determine a lack of node dependencies between the color correction and the noise reduction task, thereby determining that such tasks are independent of each other. The example pattern analyzer 304 may then suggest parallel processing of such tasks, and forward this suggestion to the optimization engine 306 for analysis. In some examples, the optimization engine 306 may determine that parallel processing of the color correction and the noise reduction task may result in a significant (e.g., 40%) increase in performance.

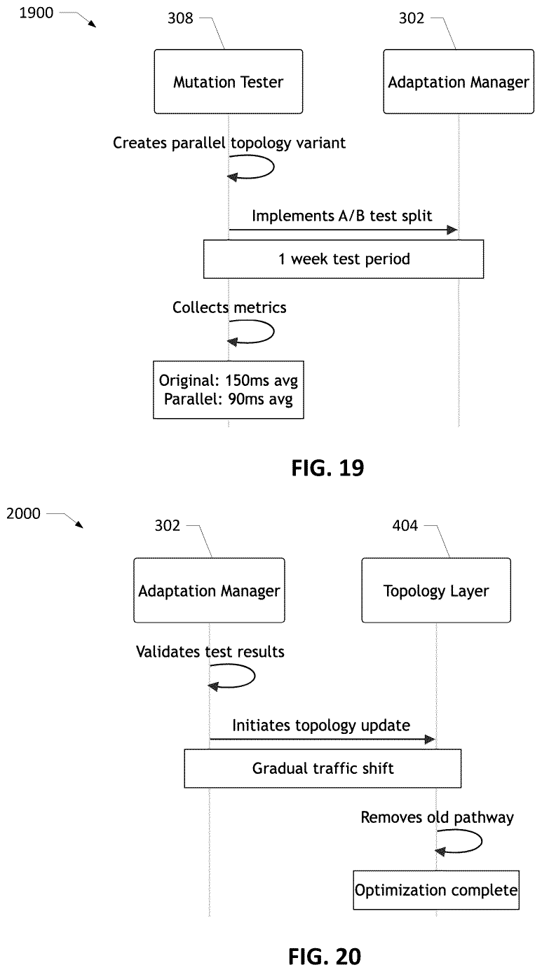

FIG. 19 is a timing diagram illustrating a process 1900 for implementing step 1606 (testing) and 1608 (analyzing patterns) of the adaptation cycle 1600, in which the mutation tester 308 and the adaptation manager 302 may work together. For example, the mutation tester 308 may create parallel topology variant(s) based on the parallel processing suggestion from the pattern analyzer 304. After creating the parallel topology variant(s), the mutation tester 308 may implement an A/B test split analyzing the prior serial topology and the parallel topology variant(s), collect metrics, and forward the results to the adaptation manager 302. In some examples, this testing may be conducted for a first threshold amount of time (e.g., at least a week) to ensure performance is consistently improved. In the illustrated example of FIG. 19, the mutation tester 308 may determine that processing the color correction and noise reduction according to the original serial topology took 150 ms on average, whereas processing the color correction and noise reduction according to the parallel topology variant(s) took 90 ms on average. In some such examples, the adaptation cycle 1600 may have resulted in a significant (e.g., 40%) reduction in processing time of the network while maintaining the same quality output.

FIG. 20 is a timing diagram illustrating a process 2000 for implementing step 1610 (deploying updates) of the adaptation cycle 1600, in which the adaptation manager 302 and the topology layer 404 may work together. For example, the adaptation manager 302 may validate the test results from the mutation tester 308. In some examples, the adaptation manager 302 may compare performance metrics of the current network topology to performance metrics of a proposed network topology and may validate the proposed network topology if the proposed network topology is an improvement over the current network topology by a threshold amount (e.g., greater than 5%). In some examples, upon successful validation, the adaptation manager may deploy the parallel topology variant(s) as a topology update for the topology layer 404. In some examples, the topology layer 404 may gradually shift network traffic according to the topology update (e.g., according to the process 1500 of FIG. 15). In some examples, the topology layer 404 may immediately shift network traffic according to the topology update. In some examples, the topology layer 404 may remove, ignore, or disregard nodes and/or connections associated with the prior topology pathways that become obsolete in view of the topology update (e.g., serial processing of color correction and noise reduction). Thereafter, the topology layer 404 may complete the optimization of the color correction and noise reduction tasks.

After deploying a network mutation, the performance monitor 310 may continue to monitor the performance of the mutated network to verify that the mutation achieves its intended improvements. In some examples, the performance monitor 310 may track whether applied mutations are successful in improving efficiency, adding capabilities, or achieving other optimization goals. This post-deployment monitoring may provide feedback that reinforces or discourages similar mutations in future adaptation cycles. For example, if a deployed mutation consistently improves performance metrics, the mutation tester 308 or optimization engine 306 may prioritize similar structural patterns or optimization strategies in subsequent hypothetical generation stages. Conversely, if a deployed mutation fails to achieve expected improvements or causes performance degradation, similar mutation patterns may be deprioritized or filtered out during future sandbox evaluation stages. This continuous feedback loop enables the adaptive computational node system to learn from operational experience and progressively improve its mutation generation and selection processes over time.

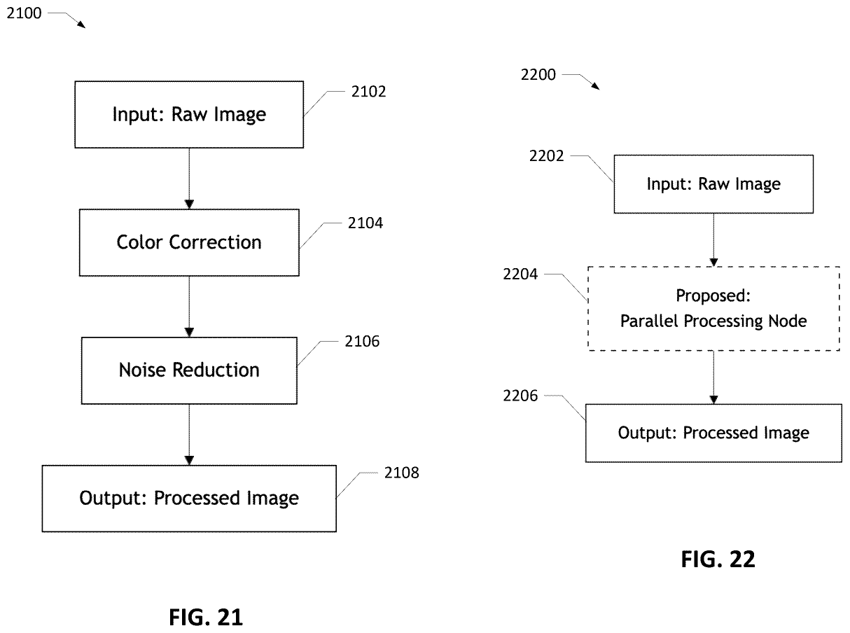

FIGS. 21-24 are flow charts illustrating an example implementation of the adaptation cycle 1600 in the image correction context, similarly as described above with reference to FIGS. 17-20. FIG. 21 is a flow chart illustrating a process 2100 for processing color correction and noise reduction of an image serially. At step 2102, the control layer 408 may receive a raw image at an input port of the network. At step 2104, the runtime layer 406 may execute color correction on the image. In some examples, the node executor 602 of the runtime layer 406 may execute a first node to perform the color correction on the image. At step 2106, the runtime layer 406 may execute noise reduction on the image. In some examples, the node executor 602 of the runtime layer 406 may execute a subsequent network node to perform the noise reduction on the image. At step 2108, the execution orchestrator 600 of the runtime layer 406 may output the processed image.

FIG. 22 is a flow chart illustrating a process 2200 for proposing parallel processing of the color correction and the noise reduction of an image. At step 2202, the control layer 408 may receive a raw image at an input port of the network. At step 2204, the mutation tester 308 may generate an efficiency solution to process color correction and noise reduction on the image in parallel. In some examples, the mutation tester 308 may propose that a first node perform the color correction on the image and a second node perform the noise reduction on the image. In some examples, the first node and the second node may be in a parallel configuration and may be executable in parallel, rather than serially. At step 2206, the execution orchestrator 600 of the runtime layer 406 may output a processed image according to the proposed parallel processing.

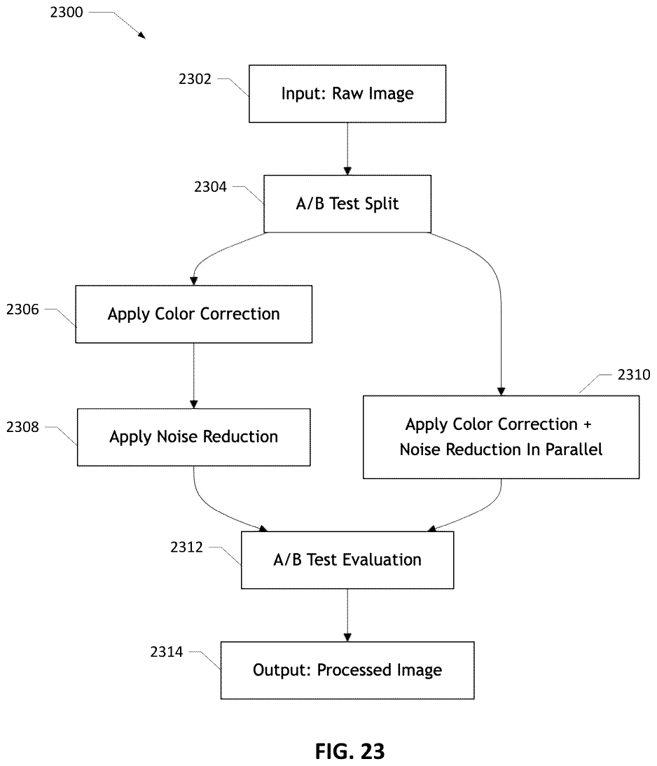

FIG. 23 is a flow chart illustrating a process 2300 for testing and evaluating the processing of the color correction and the noise reduction of an image both serially and parallelly. At step 2302, the control layer 408 may receive a raw image at an input port of the network. At step 2304, the mutation tester 308 may implement an A/B test split. For example, the mutation tester 308 may test two analyses of the color correction and noise reduction (e.g., serially and parallelly). At step 2306, the mutation tester 308 may evaluate color correction of the image being performed first (e.g., by a first node). At step 2308, the mutation tester 308 may evaluate noise reduction of the image being performed after the color correction (e.g., by a node subsequent to the first node). At step 2310, the mutation tester 308 may evaluate color correction and noise reduction of the image being performed in parallel (e.g., by a first node and a second node configured in a parallel arrangement). At step 2312, the mutation tester 308 may compile the evaluation results of the A/B test split conducted via steps 2306-2310. At step 2314, the execution orchestrator 600 of the runtime layer 406 may output processed images according to both serial and parallel processes (e.g., for evaluating the resulting image).

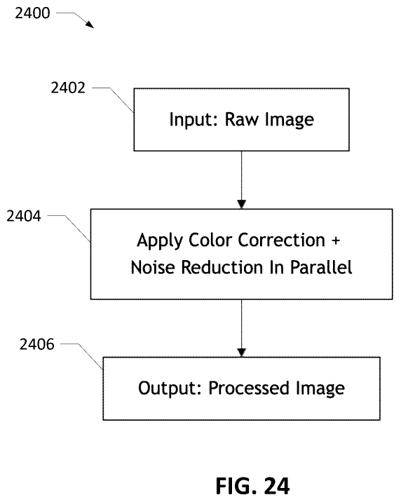

FIG. 24 is a flow chart illustrating a process 2400 for deploying optimized topology by the adaptation manager 302. At step 2402, the control layer 408 may receive a raw image at an input port of the network. At step 2404, the runtime layer 406 may execute color correction and noise reduction on the image in parallel. In some examples, the node executor 602 of the runtime layer 406 may execute a first node to perform the color correction on the image. In some examples, the node executor 602 of the runtime layer 406 may execute a second node to perform the noise reduction on the image. In some examples, the first node and the second node may be in a parallel configuration and may be executed in parallel, rather than serially. At step 2406, the execution orchestrator 600 of the runtime layer 406 may compile the results from the first node and the second node, and output the processed image.

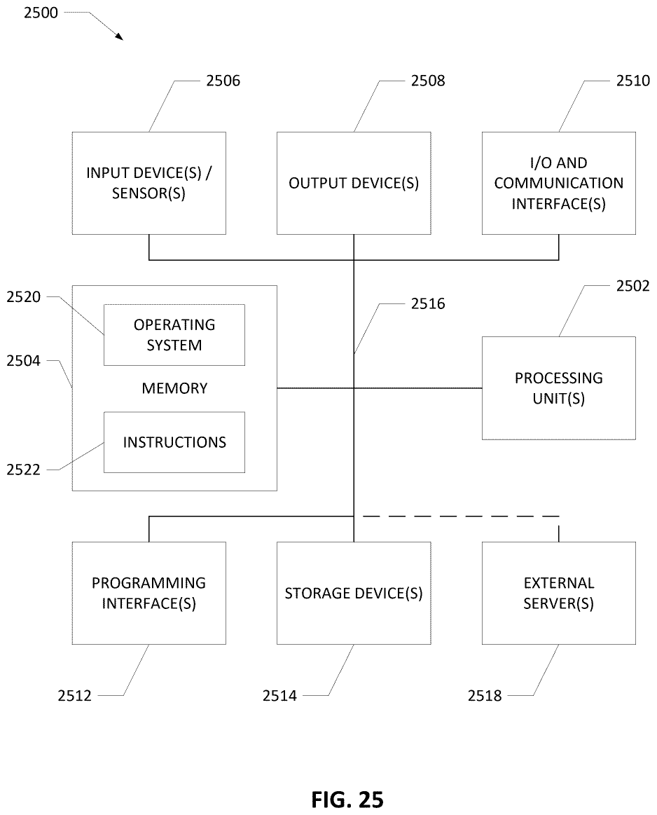

FIG. 25 illustrates an example computing device 2500 that may be used in accordance with the teachings described herein. The example computing device 2500 may be a computer, a network of computers, a tablet, a mobile device, a server, a network of servers, a workstation, an internet-of-things (IoT) device, a smart appliance, a network node, a hub, a router, a modem, or the like. The example computing device 2500 may comprise one or more processing units 2502, one or more memory 2504, one or more input devices or sensors 2506, one or more output devices 2508, one or more input/output (I/O) and communication interfaces 2510, one or more programming interfaces 2512, and one or more storage devices 2514. Each of the one or more processing units 2502, one or more memory 2504, one or more input devices or sensors 2506, one or more output devices 2508, one or more input/output (I/O) and communication interfaces 2510, one or more programming interfaces 2512, and one or more storage devices 2514 may be interconnected via wired connections such as, for example, a bus 2516. Alternatively, each of the one or more processing units 2502, one or more memory 2504, one or more input devices or sensors 2506, one or more output devices 2508, one or more input/output (I/O) and communication interfaces 2510, one or more programming interfaces 2512, and one or more storage devices 2514 may be interconnected wirelessly. In some examples, each of the one or more processing units 2502, one or more memory 2504, one or more input devices or sensors 2506, one or more output devices 2508, one or more input/output (I/O) and communication interfaces 2510, one or more programming interfaces 2512, and one or more storage devices 2514 may be interconnected via a combination of wired and wireless connections. In some examples, the example computing device 2500 may be connected to one or more external servers 2518.

In some examples, the processing unit 2502 may be circuitry or a device configured for processing data. The processing unit 2502 may be a processor such as a central processing unit (CPU), a microprocessor, integrated circuit (IC), an application-specific integrated circuit (ASIC), a Field Programmable Gate Array (FPGA), a graphical processing unit (GPU), a quantum processor, a bioprocessor, a vector processor, a graph processor, or the like. In some examples, the computing device 2500 may have one or more processing units 2502 for parallel processing. In some such examples, the one or more processing units 2502 may be of the same type (e.g., multiple microprocessors). In some examples, the one or more processing units 2502 may be of different types (e.g., at least one CPU and at least one GPU).

In some examples, the memory 2504 may be a non-transitory computer readable storage medium. In some examples, the memory 2504 may include random-access memory, such as DRAM, SRAM, DDR RAM, or other random-access solid-state memory devices. In some examples, the memory 2504 may include an operating system 2520 and instructions 2522.

The operating system 2520 may be a traditional operating system that relies on pre-defined rules and structures such as, for example, Microsoft Windows®, Linux, Android, macOS, iOS, etc. In some examples, the operating system 2520 may be an adaptive, self-modifying, and dynamic operating environment powered by the generative neural networks described herein. The operating system 2520 may be able to function effectively on a wide range of devices and platforms including smartphones, tablets, desktops, servers, etc. In some examples, the operating system 2520 may be decentralized, such that users may share resources and may collaborate without reliance on centralized servers.

The instructions 2522 may comprise computer executable instruction sets for implementing the exemplary processes 1200, 1300, 1400, 1500, 1600, 1700, 1800, 1900, 2000, 2100, 2200, 2300, 2400 described above with reference to FIGS. 12-24.

In some examples, the one or more input devices or sensors 2506 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 2508 may comprise one or more displays, one or more speakers, one or more lights (e.g., light emitting diodes), a signal generator, a haptics engine, a printer, or the like.

In some examples, the one or more I/O and communication interfaces 2510 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, 12C, or a similar type of interface.

In some examples, the one or more programming interfaces 2512 may comprise software for implementing one or more physical I/O and communication interfaces, application programming interfaces (APIs) configured for communication with and providing services to databases, software applications, the Internet, or the like.

In some examples, the one or more storage devices 2514 may comprise non-volatile memory, such as one or more magnetic disk storage devices, optical disk storage devices, flash memory devices, or other non-volatile solid-state storage devices. In some examples, the one or more storage devices 2514 may include one or more databases.

In some examples, the one or more external servers 2518 may comprise external processing and storage that may be utilized by the example computing device 2500. In some examples, the one or more external servers 2518 may be configured similarly to the example computing device 2500.

One or more example apparatus, systems, and computer-readable storage mediums are described below. An example method may comprise monitoring first performance metrics of a first network, determining, based on the monitored first performance metrics, network patterns indicative of network inefficiencies or inabilities, determining, based on the determined network patterns, a network mutation, creating, based on the first network and the network mutation, a second network, comparing the first performance metrics of the first network to second performance metrics of the second network; and based on determining that the second performance metrics are an improvement over the first performance metrics by a threshold amount, applying the network mutation to the first network.

In some methods, applying the network mutation to the first network occurs after the first network processes existing network traffic.

In some methods, applying the network mutation to the first network further comprises establishing, creating, or adding a new neural node or removing, ignoring, or disregarding an existing neural node from the first network.

In some methods, applying the network mutation to the first network further comprises establishing, creating, or adding a new connection or removing, ignoring, or disregarding an existing connection between existing nodes of the first network.

In some methods, applying the network mutation to the first network further comprises removing, ignoring, or disregarding a connection between a first node and a second node of the first network, establishing, creating, or adding a new neural node between the first node and the second node, establishing, creating, or adding a first new connection between the first node and the new neural node, and establishing, creating, or adding a second new connection between the new neural node and the second node.

In some methods, applying the network mutation to the first network further comprises modifying an existing connection between a first node and a second node by replacing metadata identifying the second node with metadata identifying a third node.

Some methods further comprise transitioning existing network traffic to pathways created by the network mutation.

An example system comprises one or more of an adaptation manager, a pattern analyzer, an optimization engine, a mutation tester, a performance monitor, a network topology manager, a topology graph, a mutation API, a topology validator, an execution orchestrator, a node executor, a signal controller, a signal store, a runtime interface, and/or a topology interface that collectively perform any of the above methods.

An example apparatus comprises one or more processors and memory storing instructions that, when executed by the one or more processors, cause performance of any of the above methods.

An example computer readable storage medium stores instructions that, when executed, cause performance of any of the above methods.

In some examples, positive reinforcement may be used to emphasize certain network topology components leading to successful task accomplishments. Accordingly, as certain components of a network are frequently used, such components may continue to be frequently used. Similarly, negative reinforcement may be used to de-emphasize certain network topology components that do not lead to successful task accomplishments. Accordingly, as certain components of a network are infrequently used, such components may continue to be used infrequently or may be removed, ignored, or disregarded completely.

Because the systems, apparatuses, and methods described herein can add nodes and connections to a network, in some examples limitations may be hard-coded into the network to avoid cascading additions of nodes or connections. In some examples, negative reinforcement may also be used to avoid exceeding available resources (e.g., local or cloud-based processing power, memory, or storage). In some examples, a signal may be issued when certain thresholds are met (e.g., 90% memory, 90% of life cycle, 90% of CPU/GPU).

In some examples, because various networks may adapt, mutate, or otherwise evolve differently, the systems, apparatuses, and methods described herein may communicate with a central hub in order to maintain consistency or consensus with the tasks being accomplished. For example, certain types of nodes, connections, or combinations that could cause physical harm may be discouraged, negatively reinforced, or outright forbidden. Similarly, certain processes (such as the order of operations for solving mathematical problems) may be reinforced to ensure calculations from differing networks arrive at a same result. The example central hub may communicate with the various networks to guide or shape the adaptation, mutation, or evolution of the networks described herein.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
one or more processors; and
memory storing instructions that, when executed by the one or more processors, cause the system to:
monitor first performance metrics of a first network;
determine, based on the monitored first performance metrics, network patterns indicative of network inefficiencies or inabilities;
determine, based on the determined network patterns, a network mutation;
create, based on the first network and the network mutation, a second network;
compare the first performance metrics of the first network to second performance metrics of the second network; and
based on determining that the second performance metrics are an improvement over the first performance metrics by a threshold amount, apply the network mutation to the first network.

2. The system of claim 1, wherein the instructions, when executed, cause the system to:
create, based on the first network, the network mutation, and different context from that of the second network, a third network;
compare the second performance metrics of the second network to third performance metrics of the third network; and
based on determining that the second performance metrics are an improvement over the third performance metrics by a threshold amount, ignore the third network.

3. The system of claim 1, wherein the instructions, when executed, cause the system to:
determine, based on monitoring the first network with the network mutation applied to the first network, third performance metrics; and
reinforce, based on determining whether the third performance metrics are an improvement over the first performance metrics, the network mutation.

4. The system of claim 1, wherein to apply the network mutation to the first network, the instructions, when executed, further cause the system to:
add a new neural node or remove an existing neural node from the first network; or
add a new connection or remove an existing connection between existing nodes of the first network.

5. The system of claim 1, wherein to apply the network mutation to the first network, the instructions, when executed, further cause the system to modify an existing connection between a first node and a second node by replacing metadata identifying the second node with metadata identifying a third node.

6. The system of claim 1, wherein the instructions, when executed, cause the system to apply the network mutation to the first network after the first network processes existing network traffic.

7. The system of claim 1, wherein the instructions, when executed, further cause the system to transition existing network traffic to pathways created by the network mutation.

8. The system of claim 1, wherein the instructions, when executed, further cause the system to create the second network by executing the network mutation in a sandbox environment isolated from real-world systems.

9. The system of claim 1, wherein the instructions, when executed, further cause the system to determine the network mutation by:
generating a plurality of candidate mutations;
evaluating the plurality of candidate mutations in sandbox environments;
filtering the plurality of candidate mutations to a subset based on the evaluating; and
selecting the network mutation from the subset.

10. The system of claim 9, wherein evaluating the plurality of candidate mutations comprises eliminating candidate mutations that produce execution errors, logical contradictions, or nonsensical outputs.

11. The system of claim 1, wherein the instructions, when executed, further cause the system to determine the network mutation by querying an inference engine to propose structural variations based on topology of the first network.

12. The system of claim 1, wherein the network mutation operates at one of:
a parameter scale modifying a single parameter within a node configuration;
a node scale adding, removing, or modifying entire nodes or connections; or
a subsystem scale affecting multiple interconnected nodes functioning as a neural flow.

13. The system of claim 4, wherein the instructions, when executed, further cause the system to add a new neural node by verifying schematic compatibility between outputs of preceding nodes and inputs of the new neural node and between outputs of the new neural node and inputs of subsequent nodes.

14. A computer readable storage medium storing instructions that, when executed, cause performance of:
monitoring first performance metrics of a first network;
determining, based on the monitored first performance metrics, network patterns indicative of network inefficiencies or inabilities;
determining, based on the determined network patterns, a network mutation;
creating, based on the first network and the network mutation, a second network;
comparing the first performance metrics of the first network to second performance metrics of the second network; and
based on determining that the second performance metrics are an improvement over the first performance metrics by a threshold amount, applying the network mutation to the first network.

15. The storage medium of claim 14, wherein the instructions, when executed, cause performance of:
determining, based on monitoring the first network with the network mutation applied to the first network, third performance metrics; and
reinforcing, based on determining whether the third performance metrics are an improvement over the first performance metrics, the network mutation.

16. The storage medium of claim 14, wherein applying the network mutation to the first network further comprises:
adding a new neural node or removing an existing neural node from the first network; or
adding a new connection or removing an existing connection between existing nodes of the first network.

17. The storage medium of claim 14, wherein the instructions, when executed, cause performance of:
creating, based on the first network, the network mutation, and different context from that of the second network, a third network;
comparing the second performance metrics of the second network to third performance metrics of the third network; and
based on determining that the second performance metrics are an improvement over the third performance metrics by a threshold amount, ignoring the third network.

18. The storage medium of claim 14, wherein applying the network mutation to the first network further comprises modifying an existing connection between a first node and a second node by replacing metadata identifying the second node with metadata identifying a third node.

19. The storage medium of claim 14, wherein applying the network mutation to the first network occurs after the first network processes existing network traffic.

20. The storage medium of claim 14, wherein the instructions, when executed, cause transitioning of existing network traffic to pathways created by the network mutation.

21. A method comprising:
at a processor:
monitoring first performance metrics of a first network;
determining, based on the monitored first performance metrics, network patterns indicative of network inefficiencies or inabilities;
determining, based on the determined network patterns, a network mutation;
creating, based on the first network and the network mutation, a second network;
comparing the first performance metrics of the first network to second performance metrics of the second network; and
based on determining that the second performance metrics are an improvement over the first performance metrics by a threshold amount, applying the network mutation to the first network.

22. The method of claim 21, further comprising:
determining, based on monitoring the first network with the network mutation applied to the first network, third performance metrics; and
reinforcing, based on determining whether the third performance metrics are an improvement over the first performance metrics, the network mutation.

23. The method of claim 21, wherein applying the network mutation to the first network further comprises:
adding a new neural node or removing an existing neural node from the first network; or
adding a new connection or removing an existing connection between existing nodes of the first network.

24. The method of claim 21, further comprising:
creating, based on the first network, the network mutation, and different context from that of the second network, a third network;
comparing the second performance metrics of the second network to third performance metrics of the third network; and
based on determining that the second performance metrics are an improvement over the third performance metrics by a threshold amount, ignoring the third network.

25. The method of claim 21, wherein applying the network mutation to the first network further comprises modifying an existing connection between a first node and a second node by replacing metadata identifying the second node with metadata identifying a third node.

26. The method of claim 21, further comprising transitioning existing network traffic to pathways created by the network mutation.
